(19) United States
(12) Patent Application Publication
(10) Pub. No.: US 2014/0160768 A1
(43) Pub. Date: Jun. 12, 2014

(54) OPTICAL LENS FOR FORMING SQUARE LIGHT PATTERN

(71) Applicants: LEDLINK OPTICS, INC., New Taipei City (TW); LEDLINK OPTICS (DONG GUAN) CO., LTD., Guangdong (CN); YANG ZHOU LEDLINK OPTICS CO., LTD., Jiangsu Province (CN)

(72) Inventors: TE-LUNG TANG, NEW TAIPEI CITY (TW); WEI-CHIANG HUANG, NEW TAIPEI CITY (TW); CHIH-MING WEI, NEW TAIPEI CITY (TW)

(73) Assignees: LEDLINK OPTICS, INC., NEW TAIPEI CITY (TW); YANG ZHOU LEDLINK OPTICS CO., LTD., JIANGSU PROVINCE (CN); LEDLINK OPTICS (DONG GUAN) CO., LTD., GUANGDONG (CN)

(21) Appl. No.: 13/707,853

(22) Filed: Dec. 7, 2012

(51) Int. Cl. F21V 5/04

(52) U.S. Cl. CPC F21V 5/04
USPC 362/335

(57) ABSTRACT

An optical lens for forming a square light pattern includes a lens body, having a light-exit surface at the top of the lens body, an incident surface at the bottom of the lens body, and a containing space concavely formed at a center position of the incident surface for containing a light emitting source, and an edge line of the incident surface is enclosed into a geometric square pattern, and a corner of the geometric square pattern is designed in an arc shape, so that after a light emitted from the light emitting source passes through the lens body, the light is projected to a target projection surface to show a square light pattern, and the optical lens can be applied to a backlight module to provide a full-screen uniform light intensity of illuminated areas.

### BACKGROUND OF THE INVENTION

1. Field of the Invention

The present invention relates to the technical area of optical lenses, in particular to the optical lens that forms square light patterns and uses a secondary optical design to adjust the light emitting angle, the light distribution, and the illumination distribution of an original light emitting source, so as to achieve an illumination effect with uniform luminous intensity.

2. Description of the Related Art

Since liquid crystal display (LCD) is a passive display device without the self-emitting function, therefore it is necessary to add and install a backlight module to provide a display light source for a display panel, and the condition whether an area light source produced by the backlight module has sufficient and uniform brightness affects the display quality of the liquid crystal display directly. At present, the backlight module can be mainly divided into two types, respectively an edge type backlight module and a direct type backlight module, wherein the direct type backlight module has the features of a high illumination uniformity, a good light-exit viewing angle, a high light energy utility rate, a simple assembly and a quick fine-tune brightness of display areas to enhance the dynamic contrast, and thus the direct type backlight module are applied extensively in large liquid crystal displays.

In addition, the LED also has the features of high light emission efficiency, long service life and low power consumption, so that the LED has become the first choice of the applications to the backlight module.

In general, a conventional direct type backlight module has a plurality of LED light sources installed on a substrate and arranged into a matrix, and a diffusion plate is covered onto the LED light sources with an appropriate distance apart from the LED light sources for uniformly scattering the light emitted from each of the LED light sources, so that the diffused lights can be projected onto a display panel to provide areas an area light source with uniform brightness. With reference to FIG. 1 for a schematic view of a light pattern of a conventional direct type backlight module projected on a diffusion plate, after a light emitted from the LED light sources passes through the optical lens, each of the light emitted from the LED light sources forms a circular light pattern 1 on the diffusion plate separately, and the circular light patterns are scattered to form an illuminated area required by the backlight module. However, a bright portion 10 is formed alternately at the junctions between the circular light patterns 1 and a dark portion 11 is formed without any light illumination, and thus the alternate bright portion 10 and dark portion 11 affect the luminous uniformity and reduce the light mixing effect of the backlight module. In addition, the liquid crystal display can change the bright and dark areas of the screen to affect the grayscale of adjacent areas on the screen, and thus causing a blooming phenomenon and resulting in lower resolution and saturation of images on screen.

Therefore, it is a main subject of the present invention to change a circular light pattern of an original LED light source by an optical lens to form closely connected and arranged square light patterns to improve the luminous uniformity and the light mixing effect. In the meantime, the present invention can also be applied to other illumination related fields that use rectangular light patterns to improve the light illumination areas and enhance the scope and efficiency of the implementation significantly.

### SUMMARY OF THE INVENTION

In view of the problems of the prior art, it is a primary objective of the present invention to provide an optical lens for forming a square light pattern, and the optical lens is applicable in a backlight light source of a liquid crystal display or an illumination area that requires rectangular light patterns, so as to improve the full-screen uniform light intensity of the illuminated areas.

To achieve the aforementioned objective, the present invention provides an optical lens for forming a square light pattern, and the optical lens comprises a lens body, a light-exit surface disposed at the top of the lens body, an incident surface at the bottom of the lens body, and a containing space concavely formed at a center position of the incident surface for containing a light emitting source, characterized in that an edge line of the incident surface is enclosed into a geometric square pattern, and a corner of the geometric square pattern is designed in a substantially arc shape, and after a light emitted from the light emitting source passes through the lens body, the light is projected to a target projection surface to show the square light pattern.

Wherein, the target projection surface is disposed on a diffusion plate of a backlight module, and the optical lens further comprises at least one latch member disposed at the bottom of the lens body for latching an LED substrate. In addition, the central position of the light-exit surface is subsided to from a concave point for providing a uniform irradiance of the light of the light emitting source projected onto the target projection surface.

To assure the shape of the square light pattern, the incident surface is projected to a relative position to the light-exit surface, and a divergence angle at a corner position of the geometric square pattern corresponding to the light-exit surface is greater than or equal to a divergence angle at a non-corner position of the geometric square pattern corresponding to the light-exit surface. Therefore, if a plurality of optical lenses is applied in the backlight module, checkerboarded arrangement of the square light patterns of the plurality of optical lenses can enhance a full-screen luminous uniformity of the backlight module, so as to improve the light mixing effect of the liquid crystal display. In addition, a rectangular light pattern formed in the illumination area also can satisfy the environment requirements of the implementation.

### BRIEF DESCRIPTION OF THE DRAWINGS

FIG. 1 is a schematic view of a light pattern projected on a diffusion plate of a conventional direct type backlight module;

FIG. 2 is a schematic view of a preferred embodiment of the present invention;

FIG. 3 is a top view of a preferred embodiment of the present invention;

FIG. 4 is a cross-sectional view of a preferred embodiment of the present invention;

FIG. 5 is a ray trace diagram of a preferred embodiment of a preferred embodiment of the present invention;

FIG. 6 is a candlepower distribution curve of a preferred embodiment of the present invention;

FIG. 7 is another candlepower distribution curve of a preferred embodiment of the present invention;

FIG. 8 is a lux diagram of a preferred embodiment of the present invention;

FIG. 9 is a schematic view of an application of a preferred embodiment of the present invention applied in a backlight module; and

FIG. 10 is a schematic view of a light pattern projected on a diffusion plate when a preferred embodiment of the present invention is applied to a backlight module.

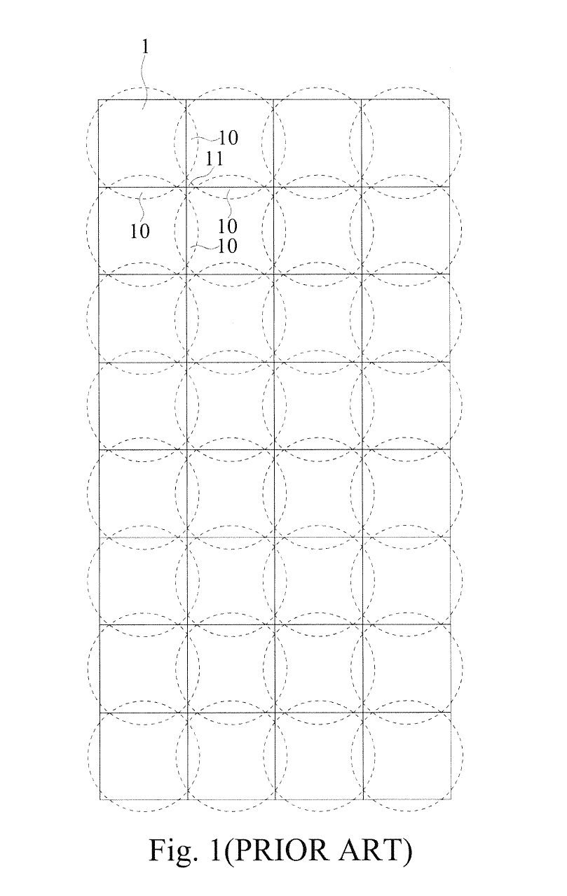

### DETAILED DESCRIPTION OF THE PREFERRED EMBODIMENTS

The technical content of the present invention will become apparent with the detailed description of preferred embodiments and the illustration of related drawings as follows.

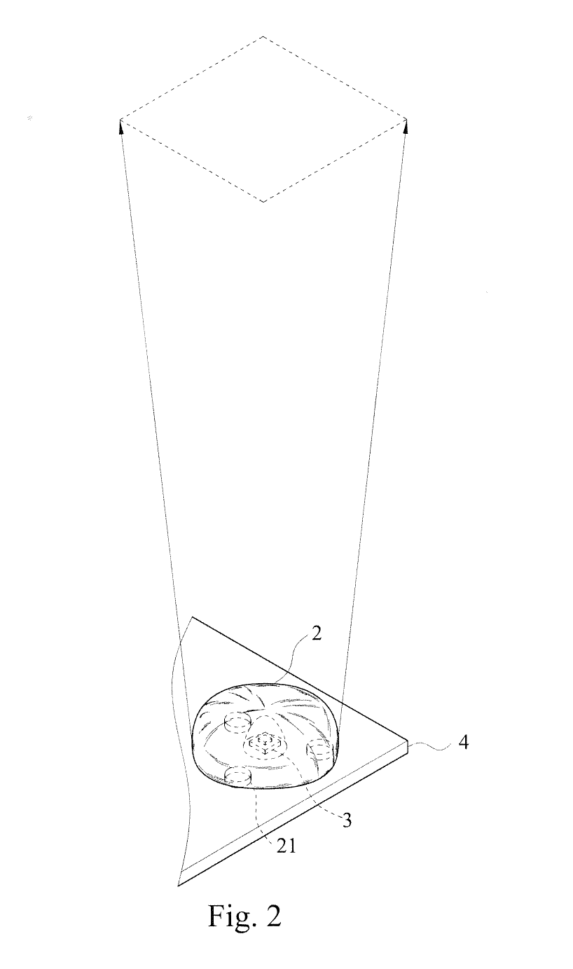

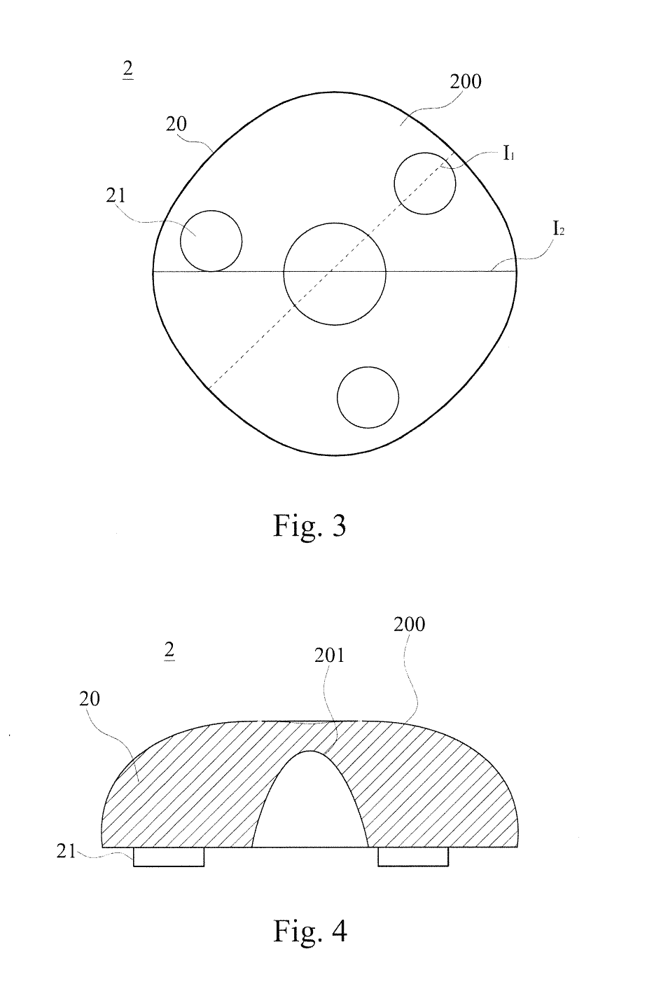

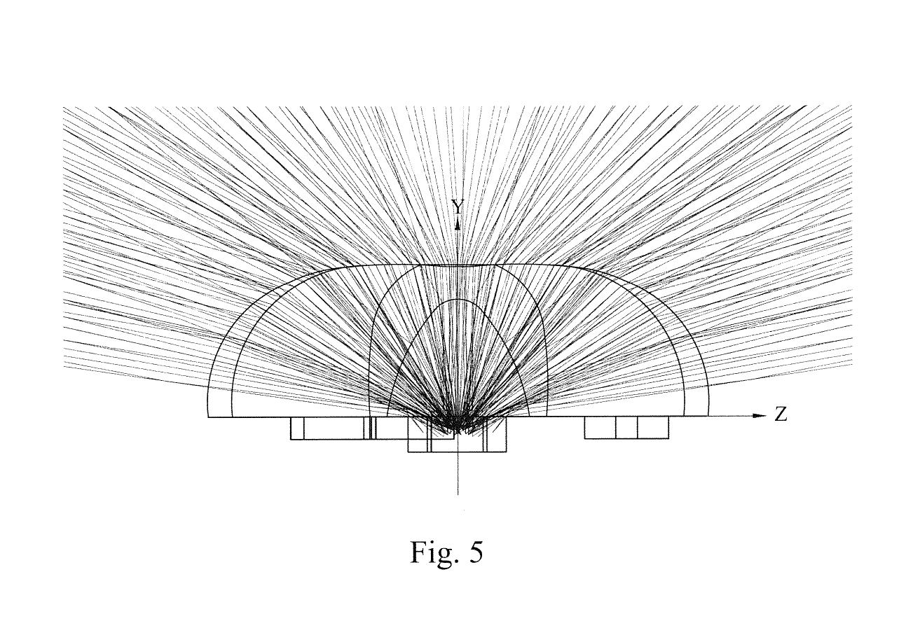

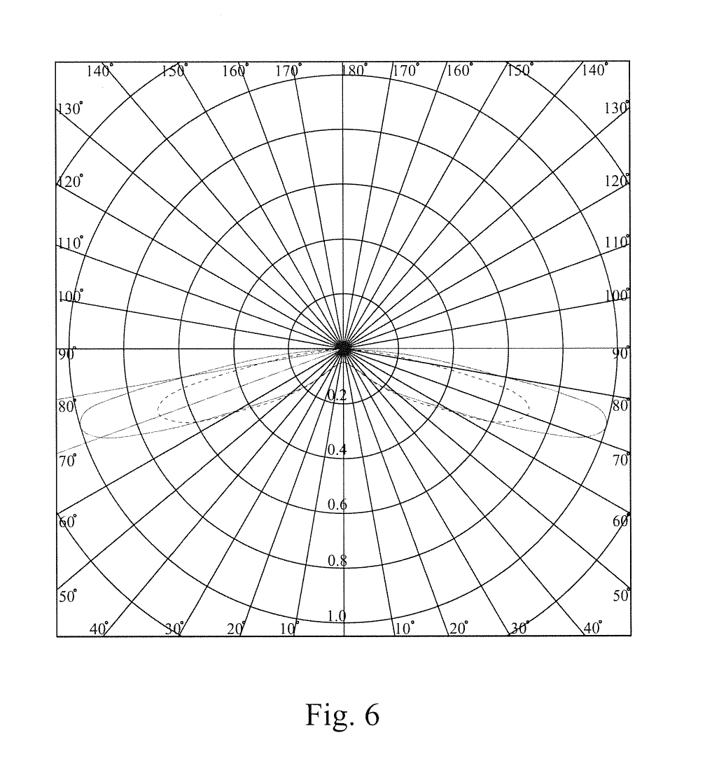

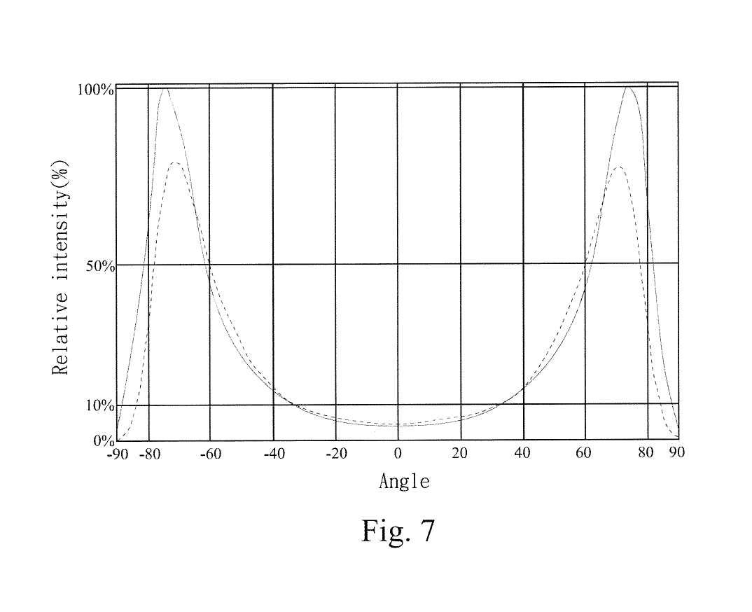

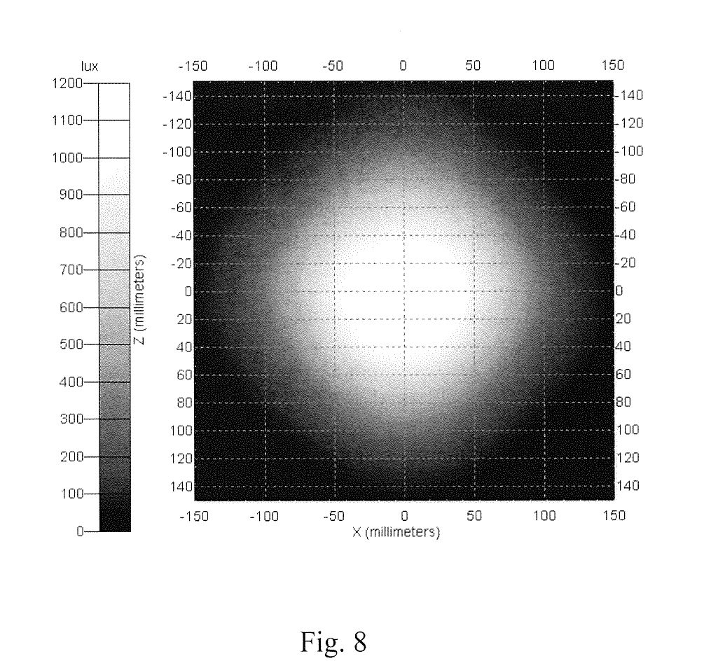

With reference to FIGS. 2 to 5 for a schematic view, a top view, a cross-sectional view, and a ray trace diagram of a preferred embodiment of the present invention respectively, an optical lens 2 for forming a square light pattern comprises a lens body 20 and at least one latch member 21 wherein a light-exit surface 200 is disposed at the top of the lens body 20, and an incident surface 201 and the latch members 21 are disposed at the bottom. A containing space is concavely formed at the center position of the incident surface 201, and the containing space is a circular conical space tapered downwardly for containing a light emitting source 3. The latch members 21 are provided for latching and fixing a LED substrate 4 and arranged equidistantly around the containing space to provide a stable supporting force to extend the applicability of the optical lens 2. In addition, an edge line of the incident surface 201 is enclosed into a geometric square pattern, and a corner of the geometric square pattern is designed in an arc shape, so that the lens body 20 is substantially a cubic structure. Therefore, a light emitted from the light emitting source 3 passes through the lens body 20 and projects to a target projection surface to achieve the light illumination effect with the square light pattern and obtain the candlepower distribution curves and the lux diagram of a preferred embodiment of the present invention as shown in FIGS. 6˜8 respectively, two opposite peripheral positions of the square light pattern have a relative intensity approximately equal to 75% provided that the light emitting angle is equal to 45˜225° with respect to a first axis I₁, and two opposite corner positions of the square light pattern have a relative intensity approximately equal to 100% provided that the light emitting angle is approximately equal to 0˜180° with respect to a second axis I₂.

In other words, the target projection surface is the incident surface 201 projected to a relative position to the light-exit surface 200, and a divergence angle at a corner position of the geometric square pattern corresponding to the light-exit surface 200 is greater than or equal to a divergence angle at a non-corner position of the geometric square pattern corresponding to the light-exit surface 200 to maintain the pattern in a square shape and prevent a deformed light pattern such as a circular light pattern caused by a relatively greater divergence angle at the peripheral positions of the geometric square pattern and improve the luminous uniformity of the light of the light emitting source 3 projected onto the target projection surface, the central position of the light-exit surface 200 is subsided to form a concave point, and the concave point with a relatively sharper corner further reflects the light of the light emitting source 3 to the central position of the light-exit surface 200 to adjust a part of the light path and distribute the intensity distribution of the light emitting source 3.

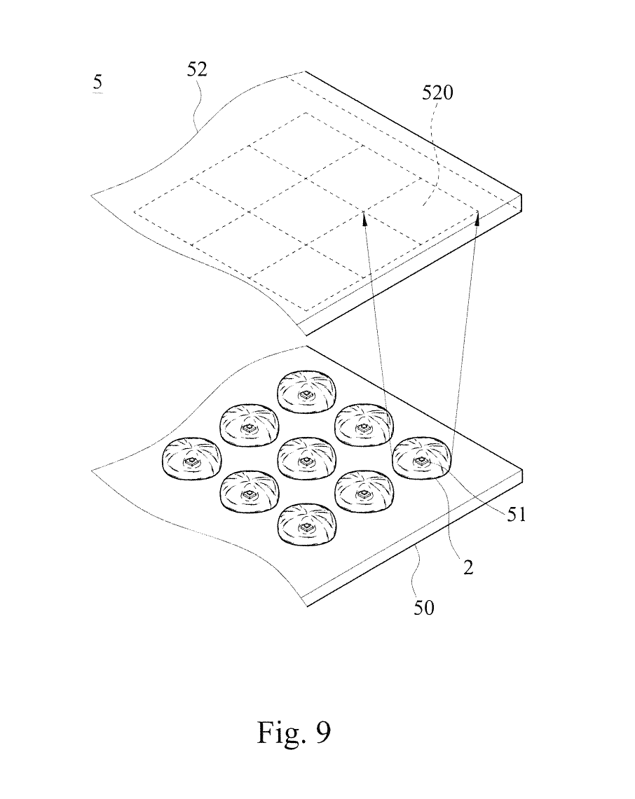

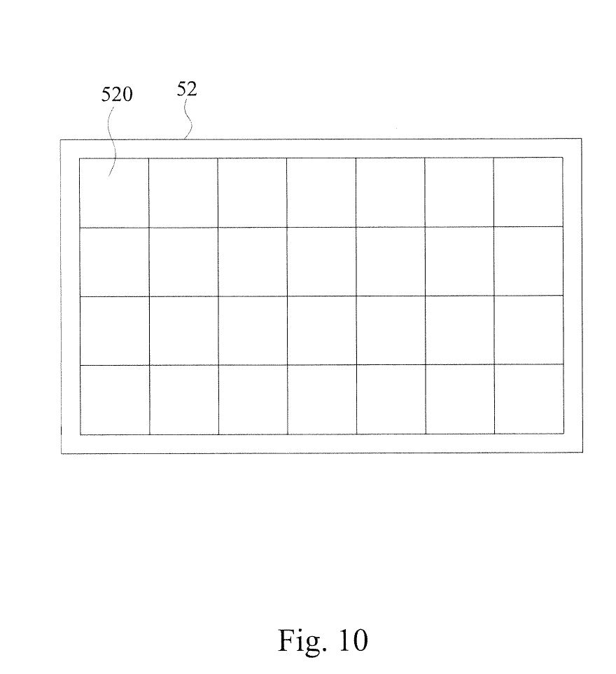

With reference to FIGS. 9 and 10 for a schematic view of an application of a preferred embodiment of the present invention applied in a backlight module and a schematic view of a light pattern projected on a diffusion plate when a preferred embodiment of the present invention is applied to a backlight module respectively, the optical lens 2 is applied in a direct type backlight module 5, and the direct type backlight module 5 is applied in a liquid crystal display for providing an illumination light source to a display module (not shown in the figure). The direct type backlight module 5 comprises a substrate 50, a plurality of LED light sources 51, a diffusion plate 52 wherein the optical lenses 2 are installed at positions corresponding to the LED light sources 51, and after the LED light sources 51 are arranged into a matrix on the substrate 50, the optical lenses 2 are fixed onto the substrate 50 by the latch members 21 which are in cylindrical shapes, and the LED light sources 51 are arranged in the containing spaces respectively. In addition, the diffusion plate 52 is covered onto the optical lenses 2 with an appropriate distance apart for scattering the light of the LED light sources 51 passing through the optical lenses 2, and then transmitting the light to the display module. Therefore, through the secondary refraction and reflection of the optical lenses 2, the lights projected by the LED light sources 51 separately form a square light pattern 520 on the diffusion plate 52 which is the target projection surface.

Since the square light patterns 520 have same-sized perimeters, therefore the square light patterns 520 are formed and disposed closely with one another on the diffusion plate 52. In other words, there is no difference between the bright and dark areas at the junctions of the square light patterns 520, so that the backlight module 5 has a full-screen luminous uniformity to improve the color saturation and resolution of screens of the liquid crystal display, so as to satisfy user requirements for video entertainments.

What is claimed is:

1. An optical lens for forming a square light pattern, having a lens body, a light-exit surface disposed at the top of the lens body, an incident surface at the bottom of the lens body, and a containing space concavely formed at a center position of the incident surface for containing a light emitting source, characterized in that an edge line of the incident surface is enclosed into a geometric square pattern, and a corner of the geometric square pattern is designed in a substantially arc shape, and after a light emitted from the light emitting source passes through the lens body, the light is projected to a target projection surface to show a square light pattern.

2. The optical lens of claim 1, wherein the target projection surface is disposed on a diffusion plate of a backlight module.

3. The optical lens of claim 1, wherein the incident surface is projected to a relative position to the light-exit surface, and a divergence angle at the light-exit surface corresponding to a corner position the geometric square pattern is greater than or equal to a divergence angle at the light-exit surface corresponding to a non-corner position of the geometric square pattern.

4. The optical lens of claim 3, wherein the target projection surface is disposed on a diffusion plate of a backlight module.

5. The optical lens of claim 1, wherein the central position of the light-exit surface is subsided to from a concave point.

6. The optical lens of claim 5, wherein the target projection surface is disposed on a diffusion plate of a backlight module.

7. The optical lens of claim 1, further comprising at least one latch member disposed at the bottom of the lens body for latching and fixing an LED substrate.
